(19) United States
(12) Patent Application Publication
(10) Pub. No.: US 2025/0225227 A1
(43) Pub. Date: Jul. 10, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: QIHONG WANG, TOKYO (JP); TAIZO SHIRAI, TOKYO (JP); MASATOMO KURATA, TOKYO (JP)

(21) Appl. No.: 18/854,803

(22) PCT Filed: Mar. 2, 2023
(86) PCT No.: PCT/JP2023/007822

§ 371 Date: Oct. 7, 2024

(30) Foreign Application Priority Data
Apr. 14, 2022 (JP) 2022-066803

(51) Int. Cl. G06F 21/44

(52) U.S. Cl. CPC G06F 21/44

(57) ABSTRACT

An information processing apparatus, including: a calculating unit configured to calculate, based on the number of second communication terminals having generated a location certificate of a first communication terminal, a reliability of the location certificate; and a determining unit configured to determine, based on the reliability calculated by the calculating unit, a presence or absence of authenticity of the location certificate of the first communication terminal.

### TECHNICAL FIELD

The present disclosure relates to an information processing apparatus, an information processing method, and a program.

### BACKGROUND ART

Recently, techniques for determining a presence or absence of authenticity of a location certificate generated with respect to a communication terminal are developed. For example, PTL 1 discloses a technique of. Disclosed is a technique of verifying validity of a location certificate by comparing positional information of a mobile terminal based on a GPS (Global Positioning System) signal transmitted from a GPS satellite with positional information of the mobile terminal obtained by wireless communication transmitted from a base station.

### CITATION LIST

### Patent Literature

### PTL 1

WO 2008/010287

### SUMMARY

### Technical Problem

However, since the technique described in PTL 1 requires that a mobile terminal be mounted with an IC (Integrated Circuit) card to be used for verification, for example, applying the technique to all mobile terminals such as smartphones may be difficult.

In consideration thereof, the present disclosure proposes a novel and improved information processing apparatus, information processing method, and program which enable authenticity of a location certificate to be more readily determined.

### Solution to Problem

The present disclosure provides an information processing apparatus, including: a calculating unit configured to calculate, based on the number of second communication terminals having generated a location certificate of a first communication terminal, a reliability of the location certificate; and a determining unit configured to determine, based on the reliability calculated by the calculating unit, a presence or absence of authenticity of the location certificate of the first communication terminal.

In addition, the present disclosure provides an information processing method to be executed by a computer, including: calculating, based on the number of second communication terminals having generated a location certificate of a first communication terminal, a reliability of the location certificate; and determining, based on the calculated reliability, a presence or absence of authenticity of the location certificate of the first communication terminal.

Furthermore, the present disclosure provides a program that causes a computer to realize: a calculation function configured to calculate, based on the number of second communication terminals having generated a location certificate of a first communication terminal, a reliability of the location certificate; and a determination function configured to determine, based on the reliability calculated by the calculation function, a presence or absence of authenticity of the location certificate of the first communication terminal.

### BRIEF DESCRIPTION OF DRAWINGS

FIG. 1 is an explanatory diagram for describing an example of an information processing system according to the present disclosure.

FIG. 2 is an explanatory diagram for describing an example of processing related to generation of a location certificate according to the present disclosure.

FIG. 3 is an explanatory diagram for describing an example of a functional configuration of an application server 30 according to the present disclosure.

FIG. 4 is an explanatory diagram for describing an example of a functional configuration of a management server 40 according to the present disclosure.

FIG. 5 is an explanatory diagram for describing an example of promotion of excursion.

FIG. 6 is an explanatory diagram for describing an example of an issue when a certifying terminal 20 is an anchor apparatus.

FIG. 7 is an explanatory diagram for describing an example of an issue when the certifying terminal 20 is a mobile terminal 20A.

FIG. 8 is an explanatory diagram for describing an example of a determination of a presence or absence of authenticity.

FIG. 9 is an explanatory diagram for describing another example of a determination of a presence or absence of authenticity.

FIG. 10 is an explanatory diagram for describing an example of the mobile terminal 20A and an anchor apparatus 20B being combined to calculate reliability.

FIG. 11 is an explanatory diagram for describing an example related to a calculation of reliability when certifying terminals 20 with different reliabilities are combined.

FIG. 12 is an explanatory diagram for describing another example related to a calculation of reliability when certifying terminals 20 with different reliabilities are combined.

FIG. 13 is an explanatory diagram for describing an example of guidance information.

FIG. 14 is an explanatory diagram for describing an example of guidance information.

FIG. 15 is an explanatory diagram for describing an example where a location certificate that enables a presence or absence of authenticity to be determined is obtained from the mobile terminal 20A.

FIG. 16 is an explanatory diagram for describing another example of guidance information.

FIG. 17 is an explanatory diagram for describing another example of guidance information.

FIG. 18 is an explanatory diagram for describing information related to compensation set for each area.

FIG. 19 is an explanatory diagram for describing an example of operation processing of the management server 40 according to the present disclosure.

FIG. 20 is a block diagram showing a hardware configuration of the management server 40 according to the present disclosure.

### DESCRIPTION OF EMBODIMENTS

A preferred embodiment of the present disclosure will be described in detail with reference to the accompanying drawings below. In the present specification and the drawings, components having substantially the same functional configuration will be denoted by the same reference numerals and repeated descriptions thereof will be omitted.

In addition, “Description of Embodiments” will be described in accordance with the following order of items.
1. Overview
1.1. Overview of Information Processing System
1.2. Functional Configuration Example of Application Server 30
2. Functional Configuration Example of Management Server 40
3. Details
3.1. Background
3.2. Determination Example of Presence or Absence of Authenticity of Location Certificate
3.3. Display Example of Guidance Information
4. Operation Processing Example
5. Example of Operational Advantage
6. Hardware Configuration Example
7. Supplements

### 1. Overview

A mechanism for more easily determining authenticity of a location certificate will be described as an embodiment of the present disclosure.

### 1.1. Overview of Information Processing System

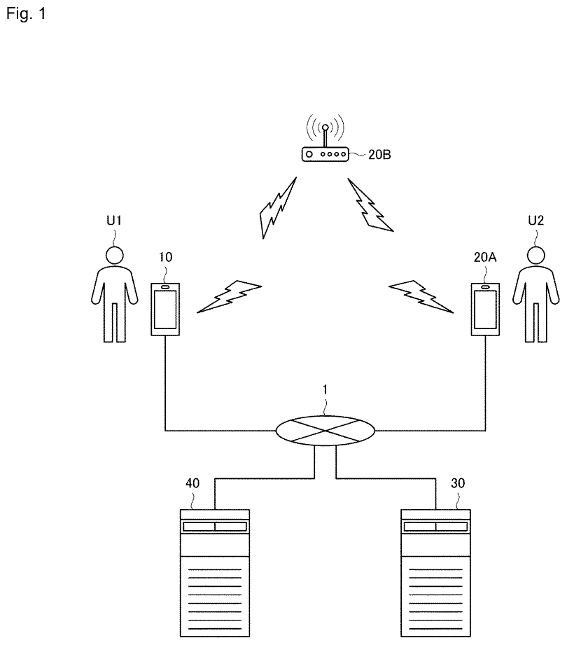

FIG. 1 is an explanatory diagram for describing an overview of an information processing system according to the present disclosure. The information processing system according to the present disclosure includes a network 1, a certified terminal 10, a certifying terminal 20, an application server 30, and a management server 40.

### Network 1

The network 1 according to the present disclosure is a wired or wireless transmission path for information transmitted from apparatuses connected to the network 1. For example, the network 1 may include public networks such as the Internet, a telephone network, and a satellite communication network, various LANs (Local Area Networks) including Ethernet (registered trademark), and a WAN (Wide Area Network).

Moreover, the network 1 may include leased line networks such as an IP-VPN (Internet Protocol-Virtual Private Network). The certified terminal 10, the certifying terminal 20, the application server 30, and the management server 40 are respectively connected via the network 1.

### Certified Terminal 10

The certified terminal 10 according to the present disclosure is an example of the first communication terminal of which a location certificate is generated by the certifying terminal 20.

The certified terminal 10 is a mobile terminal that is carried by a user U1 using an application. For example, the certified terminal 10 may be a smartphone such as that shown in FIG. 1 or various communication terminals including a tablet terminal and a smart watch.

### Certifying Terminal 20

The certifying terminal 20 according to the present disclosure is an example of the second communication terminal which generates a location certificate of the certified terminal 10.

The certifying terminal 20 may include at least two or more communication terminals of which, for example, reliabilities of location certificates differ.

For example, a communication terminal with a lowest reliability among the communication terminals included in the certifying terminal 20 may be a mobile terminal 20A that is carried by another user U2 using an application. In this case, the mobile terminal 20A may be, for example, a smartphone in a similar manner to the certified terminal 10 or various communication terminals including a tablet terminal and a smart watch. The user U1 and the user U2 are examples of the user.

In addition, in the certifying terminal 20, another terminal other than the communication terminal with the lowest reliability among the communication terminals included in the certifying terminal 20 may be an anchor apparatus 20B indicating an apparatus that is installed in each area.

Furthermore, the certifying terminal 20 may generate a location certificate of the certified terminal 10 based on a signal transmitted and received between the certifying terminal 20 and the certified terminal 10. For example, the signal transmitted and received between the certifying terminal 20 and the certified terminal 10 may be a wireless signal compliant with Near Field Communication. For example, Near Field Communication may include Bluetooth (registered trademark).

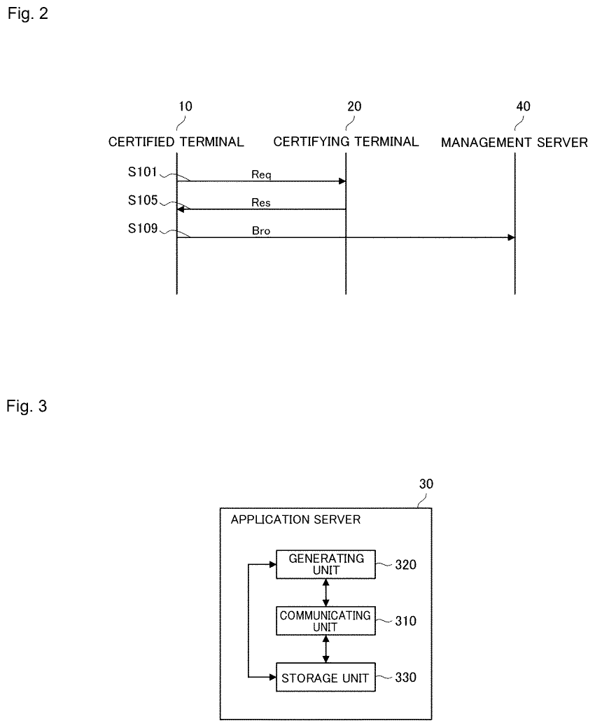

An example of processing related to generation of a location certificate will now be described with reference to FIG. 2. In FIG. 2, as an example of processing related to generation of a location certificate according to the present disclosure, processing of generating a location certificate based on public-key cryptography using a signal transmitted and received between the certified terminal 10 and the certifying terminal 20 will be described.

FIG. 2 is an explanatory diagram for describing an example of processing related to generation of a location certificate according to the present disclosure. First, the certified terminal 10 transmits a Req (Request) signal to certifying terminals 20 present in the periphery (S101). In this case, the certifying terminals 20 present in the periphery may be certifying terminals 20 included in a communication range of, for example, Bluetooth communication.

In this case, for example, the Req signal may include a public key of the certified terminal 10, positioning information (longitude, latitude, and elevation) of the certified terminal 10, various types of request information such as a time stamp, and digital signatures by a cryptographic key of the certified terminal 10 with respect to the various types of request information. In addition, when the management server 40 is included in a blockchain network, the Req signal may further include hash values of various types of information included in a previously-generated block.

Next, the certifying terminal 20 having received the Req signal verifies, using the public key of the certified terminal 10 included in the Req signal, whether or not the digital signature had been generated by the cryptographic key of the certified terminal 10 and further determines whether or not a position (latitude, longitude, and elevation) of the certified terminal 10 is within a communication range of its own position (latitude, longitude, and elevation).

When the digital signature had been generated by the cryptographic key of the certified terminal 10 and the certified terminal 10 is within the communication range, the certifying terminal 20 transmits a Res (Response) signal to the certified terminal 10 (S105).

In this case, for example, the Res signal may include the various types of request information included in the Req signal, a public key of the certifying terminal 20, positioning information (longitude, latitude, and elevation) of the certifying terminal 20, various types of response information such as a time stamp, and digital signatures by a cryptographic key of the certifying terminal 20 with respect to the various types of response information.

In addition, the certified terminal 10 having received the Res signal verifies, using the public key of the certifying terminal 20 included in the Res signal, whether or not the digital signature had been generated by the cryptographic key of the certifying terminal 20 and further determines whether or not a position (latitude, longitude, and elevation) of the certifying terminal 20 is within a communication range of its own position (latitude, longitude, and elevation).

In addition, when the digital signature had been generated by the cryptographic key of the certified terminal 20 and the certified terminal 20 is within the communication range, the certified terminal 10 transmits a Bro (Broadcast) signal to the management server 40 (S105) and ends the processing. For example, the Bro signal includes the various types of response information included in the Res signal.

This concludes the description of the example of processing related to the generation of a location certificate. While the example described above is an example of using a three-dimensional position (longitude, latitude, and elevation) in determining whether or not the position of the certifying terminal 20 is within the communication range of one's own position, for example, a two-dimensional position may be used instead. In addition, the three-dimensional position may be positioning information obtained by GNSS (Global Navigation Satellite Systems) or positional information obtained by a method that does not use satellite information. The positional information obtained by a method that does not use satellite information may be positional information obtained by, for example, indoor positioning. In this case, a three-dimensional position includes each coordinate position of an X coordinate, a Y coordinate, and a Z coordinate from a given reference point. Once again referring to FIG. 1, the description of the overview of the information processing system will be continued.

### Application Server 30

The application server 30 according to the present disclosure is a server that operates an application.

For example, the application server 30 operates an application that provides compensation commensurate with the location certificate generated by the certifying terminal 20. A specific example of the functional configuration of the application server 30 will be described later.

### Management Server 40

The management server 40 according to the present disclosure is an example of the information processing apparatus and calculates a reliability of a location certificate based on the number of certifying terminals 20 that have generated a location certificate of the certified terminal 10.

In addition, based on the calculated reliability, the management server 40 determines a presence or absence of authenticity of the location certificate of the certified terminal 10.

Furthermore, the management server 40 may be included in a blockchain network. A specific example of the functional configuration of the management server 40 will be described later.

Next, referring to FIG. 3, a functional configuration example of the application server 30 according to the present disclosure will be described.

### 1.2. Functional Configuration Example of Application Server 30

FIG. 3 is an explanatory diagram for describing an example of a functional configuration of the application server 30 according to the present disclosure. As shown in FIG. 2, the application server 30 according to the present disclosure includes a communicating unit 310, a generating unit 320, and a storage unit 330.

### Communicating Unit 310

The communicating unit 310 according to the present disclosure performs various types of communication with the certified terminal 10, the certifying terminal 20, and the management server 40.

For example, the communicating unit 310 receives information related to a declaration of movement data from the certified terminal 10. In addition, the communicating unit 310 transmits, to the management server 40, a signal that queries a location certificate of the certified terminal 10 having transmitted the information related to the declaration of movement data. Furthermore, the communicating unit 310 receives a query result of the location certificate from the management server 40.

In addition, the communicating unit 310 provides the user with compensation set in advance with respect to an area indicated by a location certificate determined to have authenticity. For example, the communicating unit 310 may transmit, to the certified terminal 10 of which a location certificate has been determined to have authenticity, compensation set in advance to the area indicated by the location certificate.

Furthermore, the communicating unit 310 may transmit guidance information generated by the generating unit 320 to the certified terminal 10. A specific example of the guidance information will be described later.

### Generating Unit 320

The generating unit 320 according to the present disclosure generates guidance information that guides a user carrying the certified terminal 10 toward an area where the certified terminal 20 with high reliability is installed. A specific example of the guidance information will be described later.

### Storage Unit 330

The storage unit 330 according to the present disclosure holds software and various kinds of data. For example, the storage unit 330 holds information related to a plurality of areas where at least one or more certified terminals 20 with high reliability are installed.

In addition, the storage unit 330 holds the plurality of areas and compensation with respect to the plurality of areas in association with each other.

Note that a part of or all of the functional configuration of the application server 30 may be included in the management server 40 to be described later. For example, the management server 40 may include a generating unit and generate guidance information that guides a user carrying the certifying terminal 10 toward an area where the certified terminal 20 with high reliability is installed. In addition, the management server 40 may use the communicating unit 420 as a part of a providing unit to provide the user with compensation set in advance with respect to an area indicated by a location certificate determined to have authenticity.

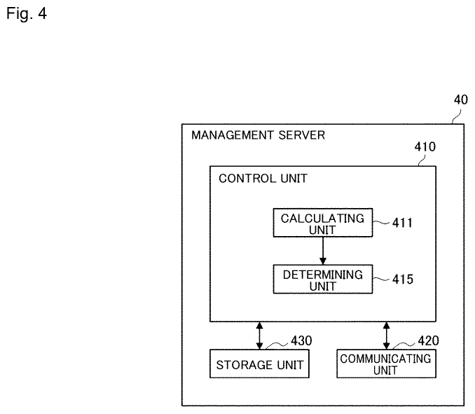

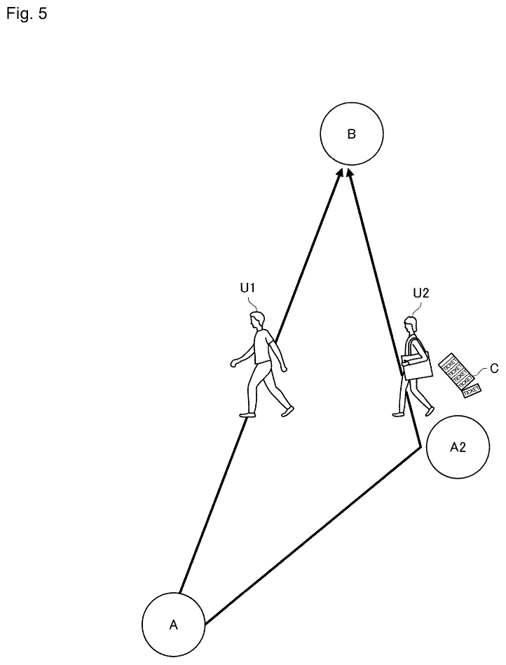

This concludes the description of an overview of the information processing system according to the present disclosure. Next, referring to FIG. 4, an example of a functional configuration of the management server 40 according to the present disclosure will be described.

### 2. Functional Configuration Example of Management Server 40

FIG. 4 is an explanatory diagram for describing an example of a functional configuration of the management server 40 according to the present disclosure. As shown in FIG. 4, the management server 40 according to the present disclosure includes a control unit 410, a communicating unit 420, and a storage unit 430.

### Control Unit 410

The control unit 410 according to the present disclosure controls overall operations of the management server 40. For example, as shown in FIG. 4, the control unit 410 includes a calculating unit 411 and a determining unit 415.

The calculating unit 411 calculates a reliability of a location certificate of the certified terminal 10 based on the number of certifying terminals 20 having generated the location certificate.

In addition, the calculating unit 411 may calculate a high reliability based on a location certificate generated by a certifying terminal 20 with high reliability (for example, the anchor apparatus 20B shown in FIG. 1) as compared to reliability based on a location certificate generated by a certifying terminal 20 with low reliability (for example, the mobile terminal 20A shown in FIG. 1).

The determining unit 413 determines a presence or absence of authenticity of a location certificate of the certified terminal 10 based on the reliability calculated by the calculating unit 411.

For example, the determining unit 413 may determine that the location certificate of the first communication terminal has authenticity when the reliability calculated by the calculating unit 411 is equal to or higher than a predetermined value and determine that the location certificate of the first communication terminal does not have authenticity when the reliability calculated by the calculating unit 411 is smaller than the predetermined value.

### Communicating Unit 420

The communicating unit 420 according to the present disclosure performs various types of communication with the certified terminal 10, the certifying terminal 20, and the application server 30. For example, the communicating unit 420 receives, from the certified terminal 10, a Bro signal including a location certificate of the certified terminal 10 generated by at least one or more certifying terminals 20.

In addition, the communicating unit 420 receives, from the application server 30, a signal that queries a location certificate of the certifying terminal 10 having transmitted information related to a declaration of movement data. Furthermore, the communicating unit 420 transmits a query result of the location certificate to the application server 30.

### Storage Unit 430

The storage unit 430 according to the present disclosure holds software and various kinds of data. For example, the storage unit 430 holds a presence or absence of authenticity of a location certificate generated with respect to the certified terminal 10 determined by the determining unit 413.

This concludes the description of the example of the functional configuration of the management server 40 according to the present disclosure. Next, details of the information processing system according to the present disclosure will be described in order with reference to FIGS. 5 to 18.

### 3. Details

### 3.1. Background

There are various utilization examples of a location certificate generated with respect to the certified terminal 10. A specific example of the utilization of a location certificate can be, for example, a use case that leads to neighborhood revitalization.

For example, a specific example of utilizing a location certificate includes certifying that a user has visited a store or that the user has participated in an event.

Another example of utilizing a location certificate is a case of promoting excursion of a town. The following description will focus on a description of an example of applying a location certificate to a case of promoting excursion of the town.

For example, users of a given train station may concentrate in a specific facility or on a specific route such as inside of the station or in a commercial facility adjacent to the station. On the other hand, there may be cases in other facilities or on other routes where excursion of users hardly occur.

In consideration, there can be a demand to promote excursion over the whole town as a part of neighborhood revitalization. For example, as an example of promoting excursion over the whole town, there is a case of providing compensation such as a localized coupon to a user who makes an excursion to a facility or a route where users are not concentrated.

FIG. 5 is an explanatory diagram for describing a case of promoting excursion. For example, a given user U1 moves from an area A to an area B along a route taken by many users. In addition, another user U2 moves from the area A to the area B via an area A2 as an example of a route that is not taken by many users.

In this case, by distributing compensation C such as a localized coupon to the other user U2 having moved via the area A2, the number of users who move via the area A2 can increase. Note that the compensation C may be any compensation that may motivate a user to make an excursion such as a discount ticket that can be used locally or points that can be exchanged with products.

When determining areas used by users as a waypoint as described above, a location certificate of a terminal (in other words, the certified terminal 10) owned by each user is desirably used.

In this case, as described above, a location certificate of the certified terminal 10 is generated by the certifying terminal 20. In addition, the certifying terminal 20 includes at least one of the mobile terminal 20A that is carried by another user or the anchor apparatus 20B that is installed in each area. Respective problems that arise in a case where the certifying terminal 20 is the mobile terminal 20A and a case where the certifying terminal 20 is the anchor apparatus 20B will now be described.

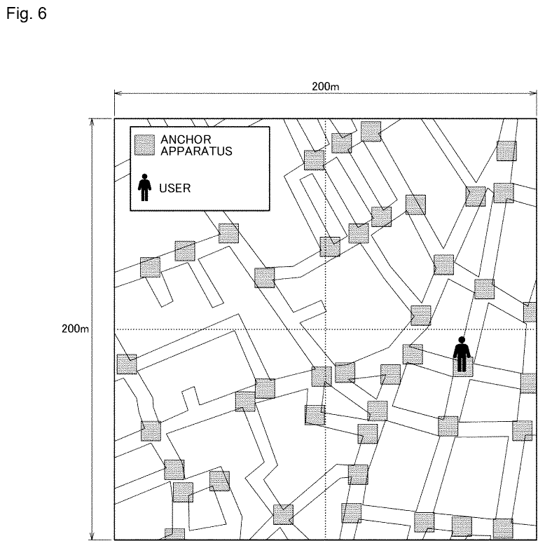

FIG. 6 is an explanatory diagram for describing an example of an issue when the certifying terminal 20 is the anchor apparatus 20B. When the certifying terminal 20 is the anchor apparatus 20B, since falsification of a location certificate by another user becomes difficult as compared to, for example, a case where the certifying terminal 20 is the mobile terminal 20A, reliability of the generated location certificate tends to be higher.

On the other hand, when a signal transmitted and received between the certifying terminal 10 and the certified terminal 20 is a signal due to Bluetooth communication, the anchor apparatus 20B is desirably present within a communication range with the certified terminal 10 and, for example, the anchor apparatus 20B is desirably arranged in each area at intervals of around 10 m. As a result, a large number of the anchor apparatuses 20B may need to be installed around the town as shown in FIG. 6.

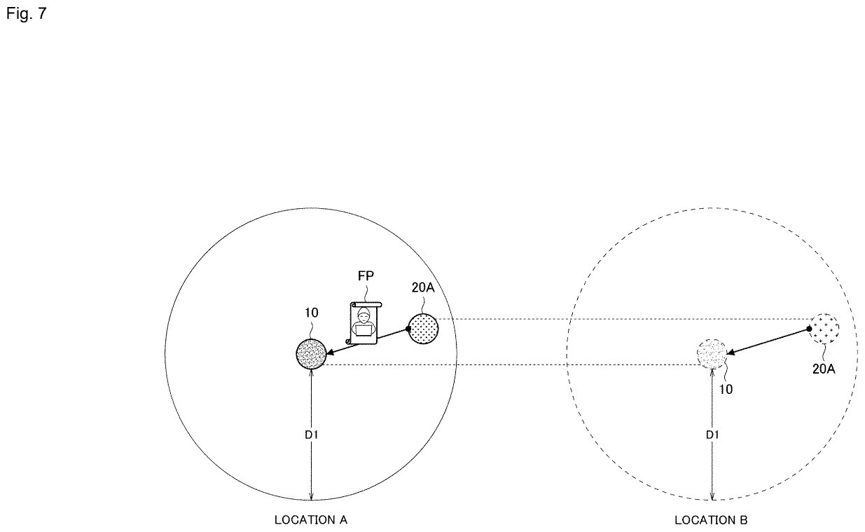

FIG. 7 is an explanatory diagram for describing an example of an issue when the certifying terminal 20 is the mobile terminal 20A. When the certifying terminal 20 is the mobile terminal 20A, since a location certificate can be generated by opportunistic communication between terminals carried by the respective user as compared to, for example, a case where the certifying terminal 20 is the anchor apparatus 20B, the hassle and costs of installing the anchor apparatuses 20B at the intervals described above may be reduced.

On the other hand, when the certifying terminal 20 is the mobile terminal 20A, a false location certificate may be generated by the mobile terminal 20A when the certified terminal 10 and the mobile terminal 20A conspire to do so. For example, a location certificate is generated by the mobile terminal 20A present within a communication range D1 of the certified terminal 10.

However, in reality, even when the certified terminal 10 and the mobile terminal 20A are present at a location A, the mobile terminal 20A can generate a false location certificate FP indicating that the certified terminal 10 is present at a location B. As described above, when the certifying terminal 20 is the mobile terminal 20A, since a collusion attack by the user carrying the certified terminal 10 and the user carrying the mobile terminal 20A is possible, reliability of a location certificate generated by the mobile terminal 20A tends to be lower as compared to a case where the certifying terminal 20 is the anchor apparatus 20B.

In other words, since the location certificate generated by the certifying terminal 20 does not necessarily certify a correct position of the certified terminal 10 and there is a possibility that the location certificate is a falsified location certificate, the presence or absence of authenticity of the location certificate is desirably determined.

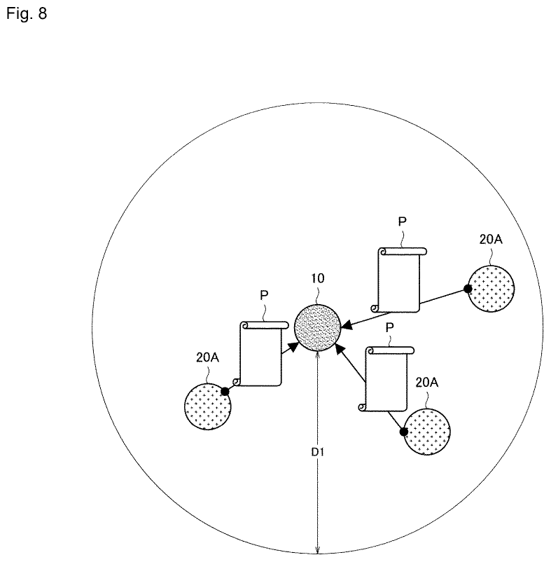

In consideration thereof, the management server 40 according to the present disclosure calculates a reliability of a location certificate of the certified terminal 10 based on the number of the certifying terminals 20 having generated the location certificate and, furthermore, determines the presence or absence of authenticity of the location certificate based on the calculated reliability. Hereinafter, details of processing related to the calculation of reliability to the determination of a presence or absence of authenticity will be described in order with reference to FIGS. 8 to 12.

### 3.2. Determination Example of Presence or Absence of Authenticity of Location Certificate

FIG. 8 is an explanatory diagram for describing an example of a determination of a presence or absence of authenticity. In FIG. 8, an example where the certified terminal 10 transmits and receives a signal to and from three mobile terminals 20A present within the communication range D1 will be described.

For example, as shown in FIG. 8, the certified terminal 10 transmits the Req signal to the three mobile terminals 20A present within the communication range D1. Each of the three mobile terminals 20A generates a location certificate P of the certified terminal 10 and transmits the generated location certificate P to the certified terminal 10. In addition, the certified terminal 10 transmits the location certificate P to the management server 40.

Next, the calculating unit 411 included in the management server 40 may calculate a reliability of the location certificate P of the certified terminal 10 based on the number of mobile terminals 20A having generated a location certificate. For example, when “number of mobile terminals 20A having generated location certificate P =reliability”, since the number of mobile terminals 20A having generated the location certificate P is three in the example shown in FIG. 8, the calculating unit 411 may calculate the reliability to be 3.

In addition, based on the reliability calculated by the calculating unit 411, the determining unit 415 determines a presence or absence of authenticity of the location certificate P of the certified terminal 10. For example, the determining unit 415 may determine the presence or absence of authenticity of the location certificate P based on whether or not the reliability calculated by the calculating unit 411 is equal to or higher than a predetermined value.

For example, when the predetermined value is 3, the determining unit 415 may determine that the location certificate P has authenticity when the reliability calculated by the calculating unit 411 is equal to or higher than 3. In addition, when the reliability calculated by the calculating unit 411 ranges from 0 to 2, the determining unit 415 may determine that the location certificate P does not have authenticity. Note that the predetermined value used in determining authenticity is not limited to 3.

Furthermore, the calculating unit 411 may calculate a high reliability based on the number of certifying terminals 20 with high reliability as compared to a reliability based on the number of certifying terminals 20 with low reliability.

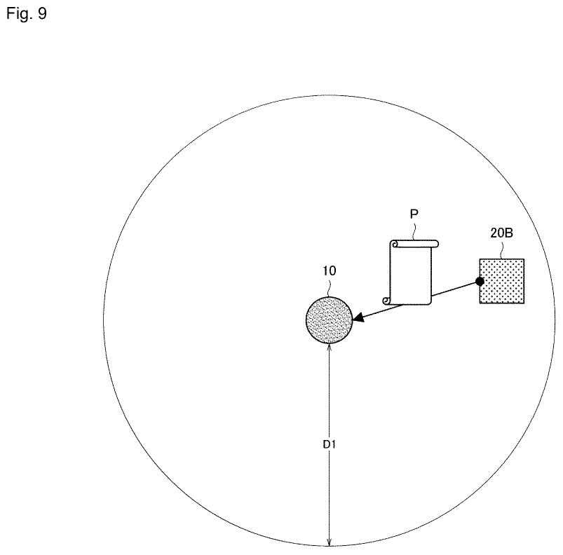

FIG. 9 is an explanatory diagram for describing another example of a determination of a presence or absence of authenticity. For example, the calculating unit 411 may calculate a high reliability based on the number of the anchor apparatuses 20B as compared to a reliability based on the number of the mobile terminals 20A.

More specifically, while the example described above is an example that the calculating unit 411 calculates the reliability as 3 when the number of mobile terminals 20A having generated the location certificate P of the certified terminal 10 is three, for example, the calculating unit 411 may calculate the reliability as 3 when the number of anchor apparatuses 20B having generated the location certificate P is one (in other words, one apparatus is equivalent to the predetermined value).

In other words, when the predetermined value used in the determination of authenticity is 3, since reliability is calculated to be 3 even when the number of anchor apparatuses 20B having generated the location certificate P is one in the example described above, the determining unit 415 may determine that the location certificate P has authenticity.

In addition, the calculating unit 411 may calculate a reliability of the location certificate P based on the number of certifying terminals 20 having generated the location certificate P of the certified terminal 10 within a predetermined amount of time. For example, when there are two mobile terminals 20A having generated the location certificate P of the certified terminal 10 within a predetermined amount of time and there is one mobile terminal 20A having generated the location certificate P of the certified terminal 10 outside of the predetermined amount of time, the calculating unit 411 may calculate a reliability by excluding the one mobile terminal 20A having generated the location certificate outside of the predetermined amount of time.

In other words, the calculating unit 411 may calculate a reliability based on two, which is the number of mobile terminals 20A having generated the location certificate P of the certified terminal 10 within the predetermined amount of time. Accordingly, since the calculating unit 411 does not use the number of certifying terminals 20 having generated the location certificate P while being separated by a certain amount of time to calculate a reliability, the reliability can be calculated with higher accuracy.

Furthermore, while the example described above is an example of the calculating unit 411 calculating a reliability based on the number of either the mobile terminals 20A or the anchor apparatuses 20B, the calculating unit 411 may calculate a reliability by combining the mobile terminals 20A and the anchor apparatuses 20B.

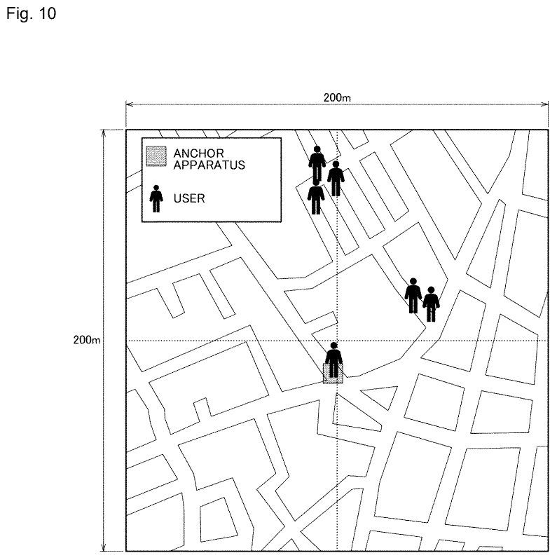

FIG. 10 is an explanatory diagram for describing an example of the mobile terminals 20A and the anchor apparatuses 20B being combined to calculate reliability. For example, as shown in FIG. 10, it is assumed that one anchor apparatus 20B is installed in each 200 m-by-200 m range.

In addition, each of the users shown in FIG. 10 is a user carrying the mobile terminal 20A. While an example where the mobile terminal 20A is the certifying terminal 20 has been mainly described, the mobile terminal 20A may become both the certified terminal 10 and the certifying terminal 20. Hereinafter, a specific example related to the calculation of reliability when certifying terminals 20 with different reliabilities are combined will be described.

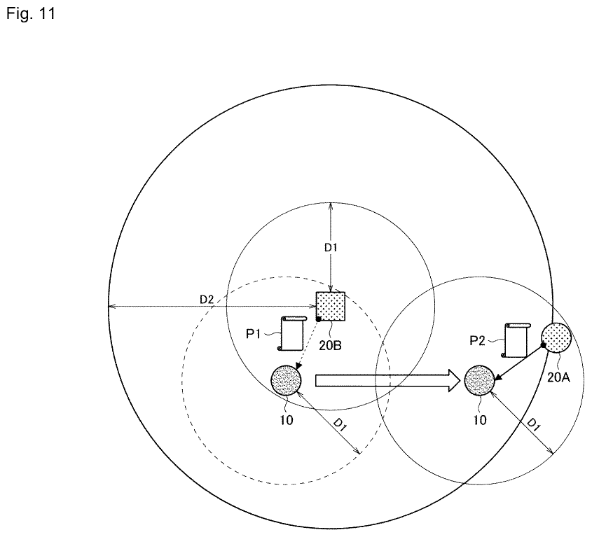

FIG. 11 is an explanatory diagram for describing an example related to the calculation of reliability when certifying terminals 20 with different reliabilities are combined. For example, the calculating unit 411 may calculate a reliability of a location certificate generated by the certifying terminal 20 (for example, the mobile terminal 20A) with a lowest reliability within a predetermined amount of time from a timing where the certifying terminal 20 (for example, the anchor apparatus 20B) with a high reliability had generated a location certificate and within a predetermined range as a reliability of a location certificate generated by the certifying terminal 20 (for example, the anchor apparatus 20B) with a high reliability.

For example, at a given timing, the anchor apparatus 20B receives a Req signal from the certified terminal 10 present within the communication range D1, generates a location certificate P1, and transmits a Res signal including the location certificate P1 to the certified terminal 10. Let us assume that, subsequently, the user carrying the certified terminal 10 has moved within a predetermined range D2 from the anchor apparatus 20B having generated the location certificate P1.

Subsequently, the mobile terminal 20A receives a Req signal from the certified terminal 10 having moved into the communication range D1 of the mobile terminal 20A, generates a location certificate P2, and transmits a Res signal including the location certificate P2 to the certified terminal 10.

In doing so, when positions of the certified terminal 10 before and after movement are included within the predetermined range D2 from the anchor apparatus 20B and an amount of time from the generation of the location certificate P1 by the anchor apparatus 20B to the generation of the location certificate P2 by the mobile terminal 20A is included in a predetermined amount of time, the calculating unit 411 may calculate a reliability of the location certificate P2 generated by the mobile terminal 20A as a reliability of the location certificate P1 generated by the anchor apparatus 20B.

In other words, instead of calculating the reliability as 1 since the number of mobile terminals 20A having generated a location certificate of the certified terminal 10 is one, the calculating unit 411 may calculate the reliability as 3 on the assumption that the number of the anchor apparatus 20B is one.

This concludes the description of an example related to the calculation of reliability in a case where certifying terminals 20 with different reliabilities are combined. However, a method of calculating a reliability when combining certifying terminals 20 with different reliabilities is not limited to the example described above.

For example, the calculating unit 411 may calculate a reliability by multiplying, by a predetermined coefficient, the number of location certificates of the certified terminal 10 having been generated by a mobile terminal 20A of which a location certificate had been generated by the anchor apparatus 20B.

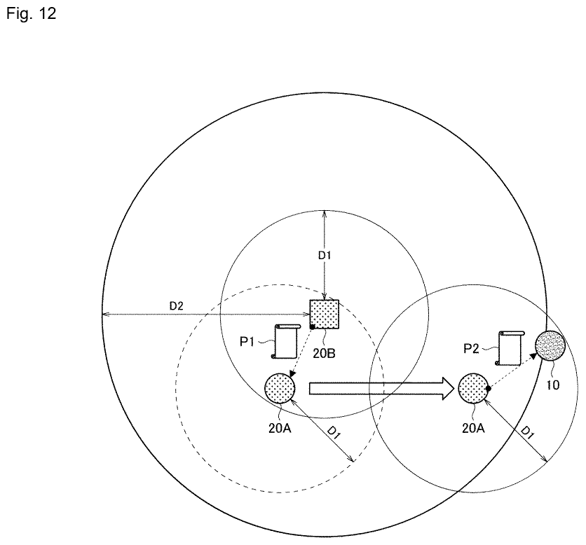

FIG. 12 is an explanatory diagram for describing another example related to a calculation of reliability when certifying terminals 20 with different reliabilities are combined. For example, the anchor apparatus 20B receives a Req signal from the mobile terminal 20A present within the communication range D1, generates the location certificate P1, and transmits a Res signal including the location certificate P1 to the mobile terminal 20A. Note that, in this case, the mobile terminal 20A corresponds to the certified terminal 10 and the anchor apparatus 20B corresponds to the certifying terminal 20.

Let us assume that, subsequently, the user carrying the mobile terminal 20A has moved within a predetermined range D2 from the anchor apparatus 20B having generated the location certificate P1. In addition, the mobile terminal 20A receives a Req signal from the certified terminal 10 present in the communication range D1, generates a location certificate P2, and transmits a Res signal including the location certificate P2 to the certified terminal 10. The mobile terminal 20A in this case corresponds to the certifying terminal 10.

In doing so, when positions of the mobile terminal 20A before and after movement are included within the predetermined range D2 from the anchor apparatus 20B, the calculating unit 411 may assume that the location certificate of the mobile terminal 20A has a certain degree of reliability and calculate a reliability by multiplying the number of the mobile terminals 20A by a predetermined coefficient.

More specifically, when X denotes the number of mobile terminals 20A of which the location certificate P1 has been generated by the anchor apparatus 20B and which have generated the location certificate P2 of the certified terminal 10 of which positions before and after movement are included within the predetermined range D2 from the anchor apparatus 20B, Y denotes the number of the mobile terminal 20A other than those having generated the location certificate P2, and K denotes a predetermined coefficient, the calculating unit 411 may calculate a reliability of the location certificate P2 of the certified terminal 10 as KX+Y.

Note that X may denote the number of mobile terminals 20A of which the location certificate P1 has been generated by the anchor apparatus 20B, which have generated the location certificate of the certified terminal 10 of which positions before and after movement are included within the predetermined range D2 from the anchor apparatus 20B, and of which a timing where the location certificate P2 had been generated is within a predetermined amount of time from a timing where the location certificate P1 had been generated.

In addition, the determining unit 415 may determine a presence or absence of authenticity of the location certificate of the certified terminal 10 according to whether or not the reliability of the location certificate calculated by the calculating unit 411 is equal to or higher than a predetermined value.

This concludes the description of a specific example related to the determination of a presence or absence of authenticity of a location certificate. In addition, the storage unit 430 may store identification information of the certified terminal 10, a location certificate of the certified terminal 10, and a determination result of a presence or absence of authenticity of the location certificate. Alternatively, the storage unit 430 may store identification information of the certified terminal 10 and a location certificate of the certified terminal 10 when it is determined that the location certificate has authenticity.

In addition, a user may declare movement data indicating a movement between areas or a stay in an area upon receiving compensation. For example, the user transmits information related to a declaration of movement data to the application server 30 using the certified terminal 10.

Next, upon receiving the information related to the declaration of movement data from the certified terminal 10, the application server 30 transmits a signal querying a location certificate of the certified terminal 10 to the management server 40.

The management server 40 transmits a determination result of a presence or absence of authenticity of the queried location certificate to the application server 30. When the application server 30 receives a determination result to the effect that the location certificate has authenticity, the application server 30 may provide a user with compensation set in advance with respect to an area indicated by the location certificate.

According to the example described above, the certified terminal 10 must approach the certifying terminal 20 to within a communication range. On the other hand, situations may arise where a location certificate of the certified terminal 10 cannot be generated such as when the certified terminal 10 is unable to approach the mobile terminal 20A or when the certified terminal 10 is present in a region where the anchor apparatus 20B has not been installed. In other words, the certified terminal 10 carried by a user may not necessarily be in a situation where a location certificate is to be generated by the certifying terminal 20.

In consideration thereof, the generating unit 320 included in the application server 30 may generate guidance information for guiding a user carrying the certified terminal 10 toward, for example, a position where the certifying terminal 20 (for example, the anchor apparatus 20B) with high reliability is installed. In addition, the communicating unit 310 may transmit the generated guidance information to the certified terminal 10.

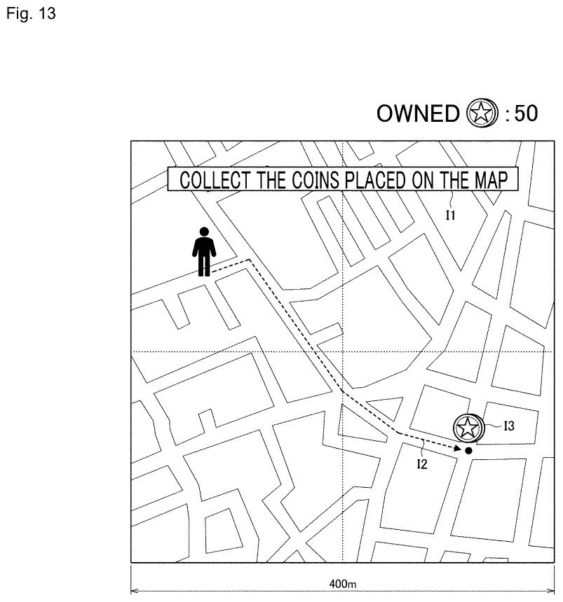

Furthermore, by having a display included in the certified terminal 10 display the guidance information, the user can be guided to the location where the anchor apparatus 20B is installed and the possibility of a location certificate being generated by the certifying terminal 20 can be improved. Hereinafter, specific examples of guidance information will be described with reference to FIGS. 13 to 18.

### 3.3. Display Example of Guidance Information

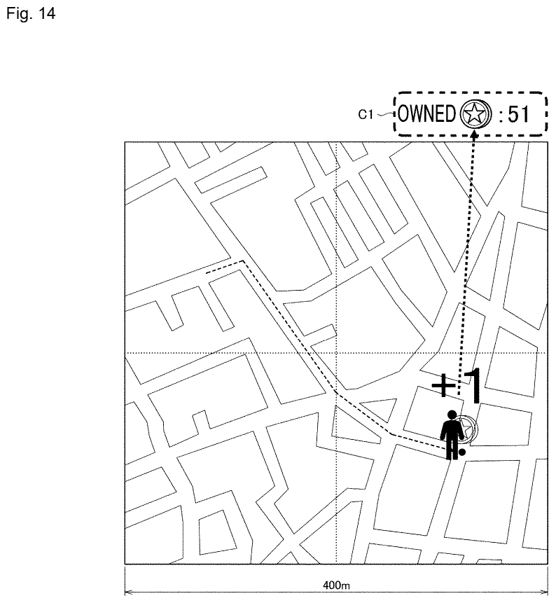

FIGS. 13 and 14 are explanatory diagrams for describing an example of guidance information. For example, the guidance information according to the present disclosure may include display information I1 including a character string for guiding to an area where the anchor apparatus 20B is installed as shown in FIG. 13.

In addition, the guidance information may include route information 12 indicating a route from a present position of a user to a position where the anchor apparatus 20B is installed as shown in FIG. 13.

Furthermore, the guidance information may include display information I3 regarding compensation that is obtained when moving to the position where the anchor apparatus 20B is installed.

Accordingly, by moving while referring to guidance information, for example, the user can move to a position where the anchor apparatus 20B is installed or to a peripheral position thereof. As a result, due to an improvement in certainty of the certified terminal 10 carried by the user of acquiring a location certificate from the anchor apparatus 20B, the user can more reliably receive the compensation set to the area where the anchor apparatus 20B is installed.

In addition, after the compensation set to the area where the anchor apparatus 20B is installed has been provided to the user, the display included in the certified terminal 10 may display notification information C1 indicating that the compensation has been acquired as shown in FIG. 14.

In addition, the user carrying the certified terminal 10 need not necessarily move to the position where the anchor apparatus 20B is installed. For example, when a location certificate that enables a presence or absence of authenticity to be determined is obtained from the mobile terminal 20A, the user carrying the certified terminal 10 need not move to the position where the anchor apparatus 20B is installed.

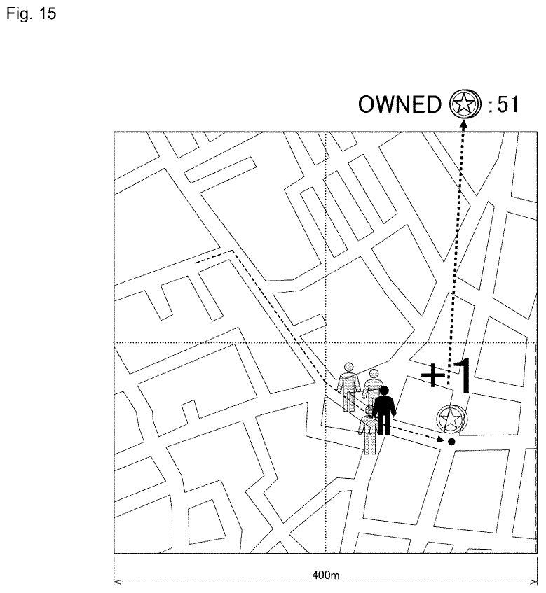

FIG. 15 is an explanatory diagram for describing an example where a location certificate that enables a presence or absence of authenticity to be determined is obtained from the mobile terminal 20A. For example, while moving to the position where the anchor apparatus 20B is installed, the certified terminal 10 may obtain, by opportunistic communication, a location certificate from the number of mobile terminals 20A which enable a presence or absence of authenticity to be determined.

In this case, the determining unit 415 can determine a presence or absence of authenticity of the location certificate of the certified terminal 10. In addition, when it is determined that the location certificate of the certified terminal 10 has authenticity, the display included in the certified terminal 10 may display notification information indicating that the compensation has been acquired.

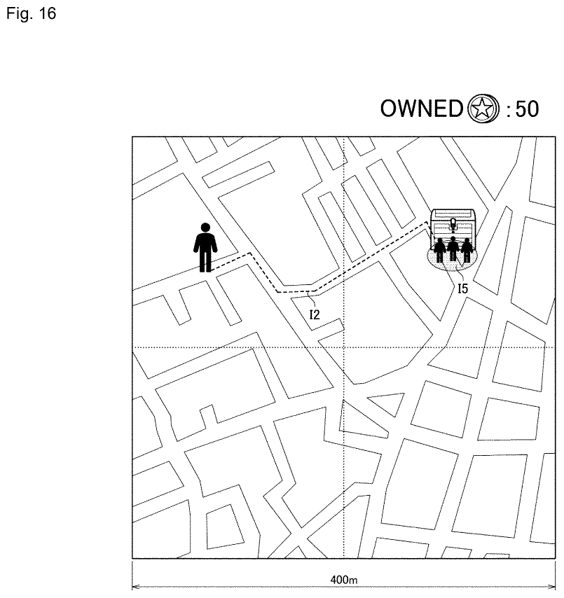

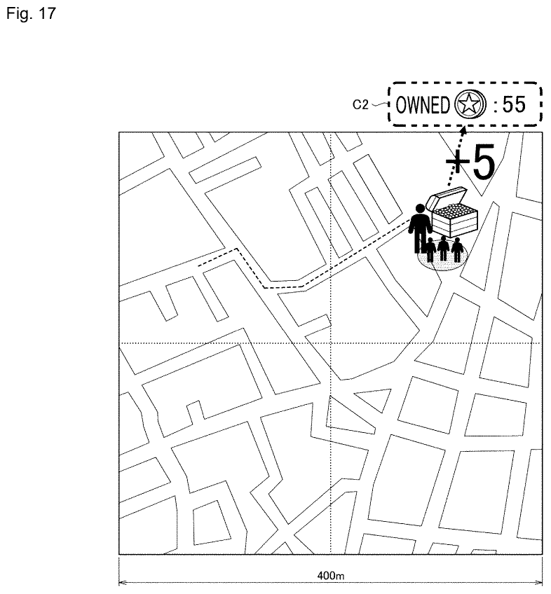

FIGS. 16 and 17 are explanatory diagrams for describing another example of guidance information. As shown in FIG. 16, the guidance information according to the present disclosure may include information 15 regarding the number of collaborators in acquiring compensation in addition to route information I2 indicating a route from a present position of the user to the position where the anchor apparatus 20B is installed.

In this case, the information 15 regarding the number of collaborators in acquiring compensation includes information corresponding to the number of certifying terminals 20 which generate a location certificate and which are necessary for reliability to be equal to or higher than a predetermined value.

For example, the information 15 regarding the number of collaborators in acquiring compensation may be the number of mobile terminals 20A present in a periphery of the compensation at the present moment. For example, when there are three users carrying the mobile terminal 20A in a periphery of the compensation at the present moment, the information 15 regarding the number of collaborators may include display information indicating that three users are present in a periphery of the compensation as shown in FIG. 16.

In addition, the information 15 regarding the number of collaborators in acquiring compensation may be the number of users corresponding to a predetermined value used when determining a presence or absence of authenticity. For example, when reliability is 3 or higher and a location certificate is determined to have authenticity and the number of mobile terminals 20A having generated the location certificate is three and reliability is calculated as 3, the information 15 regarding the number of collaborators in acquiring compensation may include display information indicating that three users are present in a periphery of the compensation as shown in FIG. 16.

Furthermore, after the number of users gathers, the location certificate is determined to have authenticity, and the compensation set to the area is provided to the users, the display included in the certified terminal 10 may display notification information C2 indicating that the compensation has been acquired.

In addition, the guidance information may include information related to compensation set for each area.

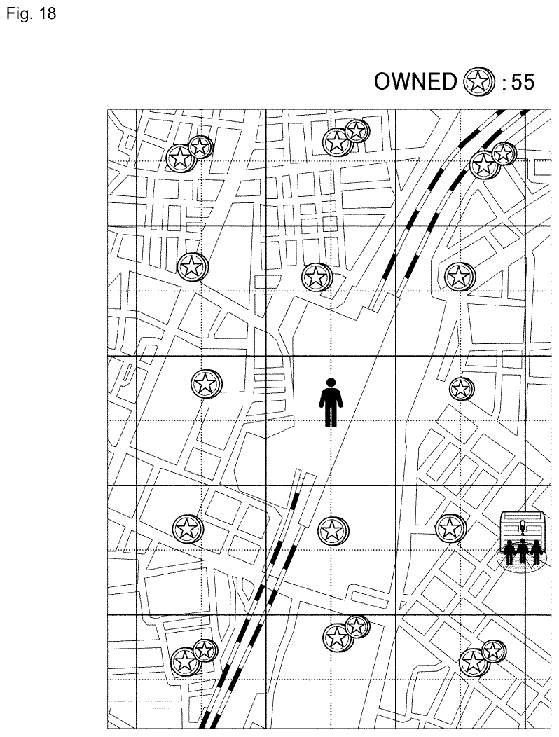

FIG. 18 is an explanatory diagram for describing information related to compensation set for each area. For example, in a case of a setting where, centered on an area of a station where a large number of users are present, the further away from the station, the larger the compensation provided to a user, the generating unit 320 may generate guidance information including information indicating compensation set for each area as shown in FIG. 18. Accordingly, the guidance information can guide users toward an area to which the users are most desirably guided (for example, an area at a distance from the station).

This concludes the description of details of the information processing system according to the present disclosure. Note that the various processing steps of the information processing system according to the present disclosure are not limited to the example described above.

For example, while the mobile terminal 20A and the anchor apparatus 20B have been described as two types of the certifying terminals 20 of which reliabilities of a location certificate differ, there may be three types of the certifying terminals 20 of which reliabilities of a location certificate differ.

When there are three types of the certifying terminals 20 of which reliabilities of a location certificate differ, for example, the anchor apparatus 20B may further include two types of apparatuses of which reliabilities of a location certificate differ. For example, the anchor apparatus 20B with a high reliability of a location certificate transmits and receives a Req signal and a Res signal to and from the certified terminal 10 over a shorter distance as compared to the anchor apparatus 20B with a low reliability of a location certificate.

More specifically, when the anchor apparatus 20B with low reliability generates a location certificate of the certified terminal 10 by the Bluetooth communication described above, the anchor apparatus 20B with high reliability may be, for example, a Felica® apparatus which generates a location certificate of the certified terminal 10 based on a signal transmitted and received to and from the certified terminal 10 over an even shorter distance than Bluetooth communication.

In this case, the calculating unit 411 may calculate a highest reliability based on the number of Felica apparatuses and calculate reliabilities in a descending order of the anchor apparatuses 20B which transmit and receive signals by Bluetooth communication and the mobile terminals 20A. Accordingly, the determining unit 415 can determine authenticity of a location certificate with higher accuracy.

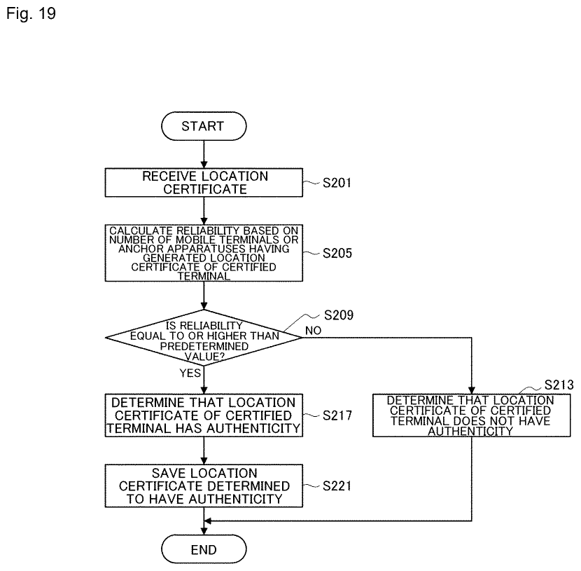

Next, referring to FIG. 19, an example of operation processing of the management server 40 according to the present disclosure will be described.

### 4. Operation Processing Example

FIG. 19 is an explanatory diagram for describing an example of operation processing of the management server 40 according to the present disclosure. First, the communicating unit 420 receives a location certificate of the certified terminal 10 having been generated by the mobile terminals 20A or the anchor apparatuses 20B which are certifying terminals 20 from certified terminal 10 (S201).

Next, based on the number of mobile terminals 20A or the anchor apparatuses 20B having generated the location certificate of the certified terminal 10, the calculating unit 411 calculates a reliability (S205).

In addition, the determining unit 415 determines whether or not the reliability calculated by the calculating unit 411 is equal to or higher than a predetermined value (S209). When the reliability is equal to or higher than the predetermined value (S209/Yes), the processing advances to S217, but when the reliability is lower than the predetermined value (S209/No), the processing advances to S213.

When the reliability is lower than the predetermined value (S209/No), the determining unit 415 determines that the location certificate of the certified terminal 10 does not have authenticity (S213) and the control unit 410 according to the present disclosure ends the processing.

When the reliability is equal to or higher than the predetermined value (S209/Yes), the determining unit 415 determines that the location certificate of the certified terminal 10 has authenticity (S217).

In addition, the storage unit 430 stores the location certificate determined to have authenticity (S221) and the control unit 410 according to the present disclosure ends the processing.

### 5. Example of Operational Advantage

According to the present disclosure described above, various operational advantages are obtained. For example, the determining unit 415 determines a presence or absence of authenticity of a location certificate of the certified terminal 10 based on a reliability calculated on the basis of the number of certifying terminals 20 having generated the location certificate. Accordingly, the certified terminal 10 need not necessarily be installed in an area where there are a large number of the anchor apparatuses 20B with high reliability and the authenticity of a location certificate can be more readily determined.

In addition, the certifying terminal 20 according to the present disclosure may include two or more communication terminals (for example, the mobile terminal 20A and the anchor apparatus 20B) of which reliabilities of a location certificate differ from each other and the calculating unit 411 may calculate a high reliability based on the number of communication terminals (for example, the anchor apparatuses 20B) with high reliability as compared to a reliability based on the number of communication terminals (for example, the mobile terminals 20A) with low reliability. Accordingly, the determining unit 415 can determine authenticity of a location certificate by utilizing respective advantages of the certifying terminals 20 with different reliabilities.

Furthermore, since using location certificates of the certifying terminals 20 with different reliabilities means that a large number of the anchor apparatuses 20B need not necessarily be installed, the determining unit 415 according to the present disclosure can realize reductions in cost and burden.

In addition, a location certificate generated by the certifying terminal 20 may be generated on the basis of public-key cryptography. Accordingly, robustness with respect to a location certificate generated by the certifying terminal 20 can be improved.

Furthermore, the calculating unit 411 according to the present disclosure may calculate a reliability of a location certificate of the certified terminal 10 based on the number of certifying terminals 20 having generated the location certificate of the certified terminal 10 within a predetermined amount of time. Accordingly, the calculating unit 411 can calculate a reliability with higher accuracy by excluding the certifying terminal 20 having generated a location certificate at a separated time from the calculation of the reliability.

In addition, the management server 40 according to the present disclosure may be included in a blockchain network. Accordingly, a risk of an occurrence of a fraudulent act such as falsification of a result of a location certificate by another user can be reduced.

Furthermore, the generating unit 320 may generate guidance information for guiding users carrying the certified terminal 10 toward a position where a communication terminal (for example, the anchor apparatus 20B) with high reliability is installed. Accordingly, the certified terminal 10 can further improve the certainty of a location certificate that enables a presence or absence of authenticity to be determined.

### 6. Hardware Configuration Example

This concludes the description of the embodiment according to the present disclosure. The various information processing steps described above are implemented by cooperation between software and hardware of the management server 40, which will be described below. The following hardware configuration is also applicable to the certified terminal 10, the certifying terminal 20, and the application server 30.

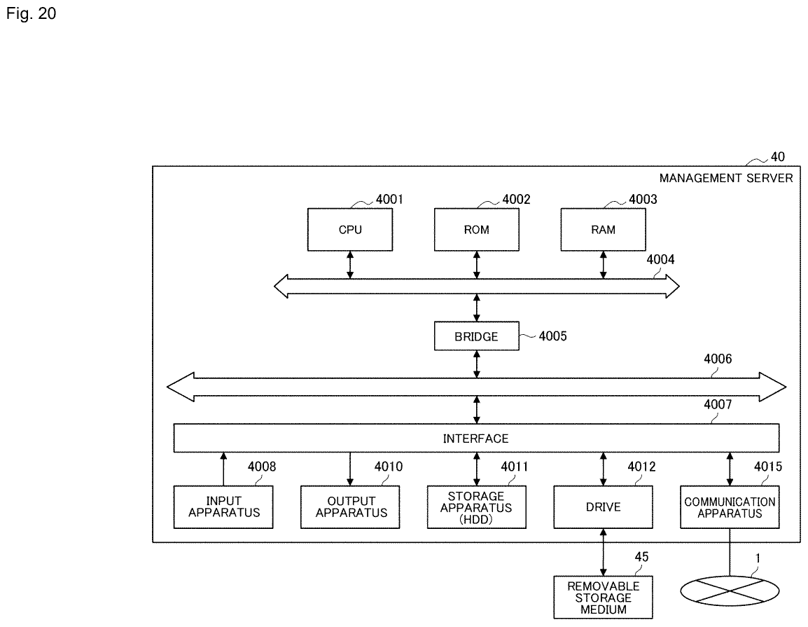

FIG. 20 is a block diagram for describing the hardware configuration of the management server 40 according to the present disclosure. The management server 40 includes a CPU (Central Processing Unit) 4001, a ROM (Read Only Memory) 4002, a RAM (Random Access Memory) 4003, a host bus 4004, a bridge 4005, an external bus 4006, an interface 4007, an input apparatus 4008, an output apparatus 4010, a storage apparatus (HDD) 4011, a drive 4012, and a communication apparatus 4015.

The CPU 4001 functions as an arithmetic processing apparatus and a control apparatus and controls overall operations in the management server 40 according to various programs. In addition, the CPU 4001 may be a microprocessor. The ROM 4002 stores a program, an arithmetic parameter, and the like used by the CPU 4001. The RAM 4003 temporarily stores a program used in execution by the CPU 4001 or a parameter or the like that is appropriately changed during execution of the program. These components are connected to one other via the host bus 4004 including a CPU bus or the like. Cooperation between the CPU 4001, the ROM 4002, and the RAM 4003 and software can implement the functions of the calculating unit 411, the determining unit 415, and the like having been described with reference to FIG. 4.

The host bus 4004 is connected to the external bus 4006 that is a PCI (Peripheral Component Interconnect/Interface) bus or the like via the bridge 4005. The host bus 4004, the bridge 4005, and the external bus 4006 need not always be separated from one another and these functions may be implemented on a single bus.

The input apparatus 4008 includes input means such as a mouse, a keyboard, a touch panel, a button, a microphone, a switch, and a lever to be used by a user to input information and an input control circuit for generating an input signal based on an input by the user and outputting the signal to the CPU 4001. A user of the management server 40 can input various kinds of data or provide an instruction of a processing operation to the management server 40 by manipulating the input apparatus 4008.

The output apparatus 4010 includes, for example, display apparatuses such as a liquid crystal display apparatus, an OLED apparatus, and a lamp. Furthermore, the output apparatus 4010 includes audio output apparatuses such as speakers and headphones. The output apparatus 4010 outputs, for example, reproduced contents. Specifically, the display apparatus displays various kinds of information including reproduced image data as a text or an image. On the other hand, the audio output apparatus converts reproduced audio data or the like into a sound and outputs the sound.

The storage apparatus 4011 is an apparatus for storing data. The storage apparatus 4011 may include a storage medium, a recording apparatus for recording data on the storage medium, a reading apparatus for reading data from the storage medium, and a deletion apparatus for deleting data recorded on the storage medium. The storage apparatus 4011 includes, for example, an HDD (Hard Disk Drive). The storage apparatus 4011 drives a hard disk and stores a program executed by the CPU 4001 and various kinds of data.

The drive 4012 is a storage medium reader/writer and is built into or externally attached to the management server 40. The drive 4012 reads information recorded on a removable storage medium 45 that is a magnetic disk, an optical disc, a magneto-optical disc, a semiconductor memory, or the like which is mounted thereon and outputs the information to the RAM 4003. Furthermore, the drive 4012 can also write information on the removable storage medium 45.

The communication apparatus 4015 is, for example, a communication interface including a communication device or the like for connection to the network 1. In addition, the communication apparatus 4015 may be a wireless LAN-compatible communication apparatus, an LTE (Long Term Evolution)-compatible communication apparatus, or a wire communication apparatus that performs wired communications.

### 7. Supplements

Although the preferred embodiment of the present disclosure has been described in detail with reference to the accompanying drawings, the present disclosure is not limited to such examples. It is apparent that those having ordinary knowledge in the technical field of the present disclosure could conceive of various modifications or changes within the scope of the technical ideas set forth in the claims, and it should be understood that such modifications and changes also naturally fall within the technical scope of the present disclosure.

For example, while an example in which the management server 40 is the information processing apparatus has been mainly described in the present specification, the functions of the information processing apparatus may be implemented by a server that integrates functional configurations of the application server 30 and the management server 40.

In addition, the steps in the processing of the management server 40 in the present specification do not necessarily have to be processed in chronological order in the order described in the flowcharts. For example, the steps in the processing of the management server 40 may be processed in an order that differs from the order described as the flowcharts or may be processed in parallel.

In addition, a computer program that causes the hardware such as the CPU, the ROM, and the RAM built into the certified terminal 10, the certifying terminal 20, the application server 30, and the management server 40 to perform the same functions as the respective components of the sa certified terminal 10, the certifying terminal 20, the application server 30, and the management server 40 described above can also be created. Furthermore, a storage medium storing the computer program is also provided.

Furthermore, the effects described in the present specification are merely explanatory or exemplary and are not intended as limiting. That is, the techniques according to the present disclosure may exhibit other effects apparent to those skilled in the art from the description herein, in addition to or in place of the above effects.

Further, the following configurations also fall within the technical scope of the present disclosure.
(1)
An information processing apparatus, including:
a calculating unit configured to calculate, based on the number of second communication terminals having generated a location certificate of a first communication terminal, a reliability of the location certificate; and
a determining unit configured to determine, based on the reliability calculated by the calculating unit, a presence or absence of authenticity of the location certificate of the first communication terminal.
(2)
The information processing apparatus according to (1), wherein
the second communication terminals include at least two or more communication terminals of which reliabilities of the location certificate differ, and
the calculating unit is configured to
calculate a high reliability based on the number of communication terminals of which the reliability is high as compared to a reliability based on the number of communication terminals of which the reliability is low.
(3)
The information processing apparatus according to (2), wherein
the determining unit is configured to
determine that the location certificate of the first communication terminal has authenticity when the reliability calculated by the calculating unit is equal to or higher than a predetermined value and determine that the location certificate of the first communication terminal does not have authenticity when the reliability is lower than the predetermined value.
(4)
The information processing apparatus according to (3), wherein
the location certificate is based on a signal transmitted and received between the first communication terminal and the second communication terminals.
(5)
The information processing apparatus according to (4), wherein
the location certificate is generated on the basis of public-key cryptography.
(6)
The information processing apparatus according to (5), wherein
the signal includes a wireless signal compliant with Near Field Communication.
(7)
The information processing apparatus according to any one of (3) to (6), wherein a communication terminal of which the reliability is the lowest among the first communication terminal and the communication terminals included in the second communication terminals is carried by a user.
(8)
The information processing apparatus according to (7), wherein
another terminal excluding the communication terminal of which the reliability is the lowest in the communication terminals included in the second communication terminals is installed in each area.
(9)
The information processing apparatus according to any one of (3) to (8), wherein the calculating unit is configured to
calculate the reliability based on the number of the second communication terminals having generated the location certificate of the first communication terminal within a predetermined amount of time.
(10)
The information processing apparatus according to (9), wherein
the calculating unit is configured to
calculate, as a reliability of the location certificate generated by a communication terminal of which the reliability is high, a reliability of the location certificate generated by a communication terminal of which the reliability is the lowest within a predetermined amount of time from a timing at which the communication terminal of which the reliability is high had generated the location certificate and within a predetermined range from the communication terminal of which the reliability is high.
(11)
The information processing apparatus according to (10), wherein
the calculating unit is configured to
calculate the reliability by multiplying, by a predetermined coefficient, the number of location certificates of the first communication terminal having been generated by the communication terminal of which the reliability is the lowest of which a location certificate had been generated by the communication terminal of which the reliability is high.
(12)
The information processing apparatus according to any one of (3) to (11), wherein the information processing apparatus is included in a blockchain network.
(13)
The information processing apparatus according to (12), further including
a generating unit configured to generate guidance information for guiding the user carrying the first communication terminal toward a position where the communication terminal of which the reliability is high is installed.
(14)
The information processing apparatus according to (13), further including
a providing unit configured to provide the user with compensation set in advance with respect to an area indicated by the location certificate determined by the determining unit to have authenticity.
(15)
The information processing apparatus according to (14), wherein
the generating unit is configured to
generate the guidance information corresponding to the number of the second communication terminals of which the reliability is equal to or higher than a predetermined value.
(16)
The information processing apparatus according to any one of (2) to (15), wherein the two or more communication terminals are two communication terminals, and a reliability based on the location certificate generated by the communication terminal of which the reliability is high is calculated as the predetermined value.
(17)
The information processing apparatus according to any one of (2) to (15), wherein the two or more communication terminals are three communication terminals, and a communication terminal of which a reliability of the location certificate is highest generates the location certificate based on a signal transmitted to and received from the first communication terminal over a shorter distance as compared to a communication terminal of which a reliability of the location certificate is second highest.
(18)
An information processing method to be executed by a computer, including:
calculating, based on the number of second communication terminals having generated a location certificate of a first communication terminal, a reliability of the location certificate; and
determining, based on the calculated reliability, a presence or absence of authenticity of the location certificate of the first communication terminal.
(19)
A program that causes a computer to realize:
a calculation function configured to calculate, based on the number of second communication terminals having generated a location certificate of a first communication terminal, a reliability of the location certificate; and
a determination function configured to determine, based on the reliability calculated by the calculation function, a presence or absence of authenticity of the location certificate of the first communication terminal.

### REFERENCE SIGNS LIST

1 Network
10 Certified terminal
20 Certifying terminal
30 Application server
310 Communicating unit
320 Generating unit
330 Storage unit
40 Management server
410 Control unit
411 Calculating unit
415 Determining unit
420 Communicating unit
430 Storage unit

1. An information processing apparatus, comprising:
a calculating unit configured to calculate, based on the number of second communication terminals having generated a location certificate of a first communication terminal, a reliability of the location certificate; and
a determining unit configured to determine, based on the reliability calculated by the calculating unit, a presence or absence of authenticity of the location certificate of the first communication terminal.

2. The information processing apparatus according to claim 1, wherein
the second communication terminals include at least two or more communication terminals of which reliabilities of the location certificate differ, and
the calculating unit is configured to
calculate a high reliability based on the number of communication terminals of which the reliability is high as compared to reliability based on the number of communication terminals of which the reliability is low.

3. The information processing apparatus according to claim 2, wherein
the determining unit is configured to
determine that the location certificate of the first communication terminal has authenticity when the reliability calculated by the calculating unit is equal to or higher than a predetermined value and determine that the location certificate of the first communication terminal does not have authenticity when the reliability is lower than the predetermined value.

4. The information processing apparatus according to claim 3, wherein
the location certificate is based on a signal transmitted and received between the first communication terminal and the second communication terminals.

5. The information processing apparatus according to claim 4, wherein
the location certificate is generated on the basis of public-key cryptography.

6. The information processing apparatus according to claim 5, wherein
the signal includes a wireless signal compliant with Near Field Communication.

7. The information processing apparatus according to claim 6, wherein
a communication terminal of which the reliability is the lowest among the first communication terminal and the communication terminals included in the second communication terminals is carried by a user.

8. The information processing apparatus according to claim 7, wherein
another terminal excluding the communication terminal of which the reliability is the lowest in the communication terminals included in the second communication terminals is installed in each area.

9. The information processing apparatus according to claim 8, wherein
the calculating unit is configured to
calculate the reliability based on the number of the second communication terminals having generated the location certificate of the first communication terminal within a predetermined amount of time.

10. The information processing apparatus according to claim 9, wherein
the calculating unit is configured to
calculate, as a reliability of the location certificate generated by a communication terminal of which the reliability is high, a reliability of the location certificate generated by a communication terminal of which the reliability is the lowest within a predetermined amount of time from a timing at which the communication terminal of which the reliability is high had generated the location certificate and within a predetermined range from the communication terminal of which the reliability is high.

11. The information processing apparatus according to claim 10, wherein
the calculating unit is configured to
calculate the reliability by multiplying, by a predetermined coefficient, the number of location certificates of the first communication terminal having been generated by the communication terminal of which the reliability is the lowest of which a location certificate had been generated by the communication terminal of which the reliability is high.

12. The information processing apparatus according to claim 11, wherein
the information processing apparatus is included in a blockchain network.

13. The information processing apparatus according to claim 12, further comprising
a generating unit configured to generate guidance information for guiding the user carrying the first communication terminal toward a position where the communication terminal of which the reliability is high is installed.

14. The information processing apparatus according to claim 13, further comprising
a providing unit configured to provide the user with compensation set in advance with respect to an area indicated by the location certificate determined by the determining unit to have authenticity.

15. The information processing apparatus according to claim 14, wherein
the generating unit is configured to
generate the guidance information corresponding to the number of the second communication terminals of which the reliability is equal to or higher than a predetermined value.

16. The information processing apparatus according to claim 15, wherein
the two or more communication terminals are two communication terminals, and a reliability based on the location certificate generated by the communication terminal of which the reliability is high is calculated as the predetermined value.

17. The information processing apparatus according to claim 15, wherein
the two or more communication terminals are three communication terminals, and
a communication terminal of which a reliability of the location certificate is the highest generates the location certificate based on a signal transmitted to and received from the first communication terminal over a shorter distance as compared to a communication terminal of which a reliability of the location certificate is second highest.

18. An information processing method to be executed by a computer, comprising:
calculating, based on the number of second communication terminals having generated a location certificate of a first communication terminal, a reliability of the location certificate; and
determining, based on the calculated reliability, a presence or absence of authenticity of the location certificate of the first communication terminal.

19. A program that causes a computer to realize:
a calculation function configured to calculate, based on the number of second communication terminals having generated a location certificate of a first communication terminal, a reliability of the location certificate; and
a determination function configured to determine, based on the reliability calculated by the calculation function, a presence or absence of authenticity of the location certificate of the first communication terminal.
